(19) United States
(12) Patent Application Publication
(10) Pub. No.: US 2021/0052109 A1
(43) Pub. Date: Feb. 25, 2021

(54) Prtable picnic barbecue grill

(71) Applicant: Dongguan Chunyuan Environmental Protection Technology Co., Ltd, Dongguan (CN)

(72) Inventor: Chicai Zheng, Dongguan (CN)

(73) Assignee: Dongguan Chunyuan Environmental Protection Technology Co., Ltd

(21) Appl. No.: 17/092,354

(22) Filed: Nov. 9, 2020

(30) Foreign Application Priority Data
Jan. 10, 2020 (CN) 202010026204.8

(51) Int. Cl. A47J 37/07; F24B 13/04; F24B 1/00; F23B 20/00; F23L 5/02

(52) U.S. Cl. CPC A47J 37/0763; A47J 37/0754; A47J 37/0786; F23L 5/02; F24B 1/003; F23B 20/00; F24B 13/04

(57) ABSTRACT

The present disclosure belongs to the technical field of barbecue products, especially a portable picnic barbecue grill, comprises a furnace shell, wherein top side of the furnace shell is provided with a feeding port with a slope structure, bottom side of the furnace shell is provided with a blower nozzle, inside of the furnace shell is fixedly provided with a hearth, the hearth comprises a feeding hopper at the top and a combustion chamber at the bottom, the feeding hopper and the combustion chamber are combined to form the hearth with an I-shaped structure; the top of the furnace shell is provided with three movable brackets that are rotatably connected by a mounting frame, a furnace end is automatically adaptable to the bottom of the pot through the movable brackets and is suitable for different sizes of woks or grills. The present disclosure has a wide range of applications.

### TECHNICAL FIELD

The present disclosure belongs to the technical field of barbecue products, and specifically relates to a portable picnic barbecue grill.

### BACKGROUND

Barbecue may be the most primitive cooking method for humans, uses fuel to heat and dry air, and places the food in the hot dry air at a position closer to the heat source to heat the food. Generally speaking, barbecue is to cook food (mostly meat, seafood, vegetables) on fire until it is edible; in modern society, due to many ways of using fire, barbecue methods are gradually diversified, and various types of barbecue grills, barbecue frames, and barbecue sauces have been developed. Barbecue itself has become a multi-person gathering leisure entertainment or business. In China, Asia, America, or Europe, barbecues are usually group activities ranging from families to schools, as well as group activities organized by some companies. At present, the commonly used tool for barbecue is a grill.

There are many kinds of existing grills, but most of the grills are relatively simple in structure, it is difficult to ignite, the burning time is short, the flame cannot be concentrated, and the grilling speed is slow. When adding charcoal fire, the grill needs to be removed before adding charcoal fire, and it is more troublesome to use.

Therefore, the present disclosure proposes a portable picnic barbecue grill to meet the problems proposed in the above background.

### SUMMARY

In order to solve the problems proposed in the above background, the present disclosure provides a portable picnic barbecue grill, which has the characteristics, that it is simple and reasonable structure, convenient to use, simple in operation, convenient to add charcoal fire, concentrated in the middle of the flame non-dispersive, good in heating effect and fuel-saving.

In order to achieve the above objective, the present disclosure provides the following technical solutions: a portable picnic barbecue grill, comprising a furnace shell, wherein the top side of the furnace shell is provided with a feeding port with a slope structure, the bottom side of the furnace shell is provided with a blower nozzle, the inside of the furnace shell is fixedly provided with a hearth, the hearth comprises a feeding hopper at the top and a combustion chamber at the bottom, the feeding hopper and the combustion chamber are combined to form the hearth with an I-shaped structure, the bottom end of the furnace shell is screwed and fixed with a supporting tripod through a fixing frame, the top end of the furnace shell is fixedly provided with a movable bracket through a mounting frame, the movable bracket is rotatably connected with the mounting frame, the outer bottom end of the furnace shell is screwed and fixed with an air blower, the output end of the air blower passes through the blower nozzle and communicates with the inside of the combustion chamber, and the air blower is electrically connected to an external power supply.

Preferably, the number of the movable brackets and the number of the supporting tripods are both three, and the three supporting tripods and movable brackets are distributed axial-symmetrically on the top and bottom ends of the furnace shell.

Preferably, the top contact surface of the mounting frame is provided with a plurality of zigzag protrusions.

Preferably, a blanking port is provided in the middle of the feeding hopper, and the output end of the feeding port is connected with the input end of the blanking port.

Preferably, both the feeding hopper and the combustion chamber are provided with a plurality of air vents.

Preferably, the inner wall of the furnace shell is fixedly provided with six supporting rods distributed axial-symmetrically.

Preferably, a plurality of ventilation holes are provided on the furnace shell.

Preferably, the outer wall of the furnace shell is screwed with an anti-scalding handle, the anti-scalding handle is a “concave”-type structure, and the grip part of the anti-scalding handle is covered with a rubber sleeve.

Preferably, the supporting tripod is movably connected with the fixing frame.

Compared with the prior art, the beneficial effects of the present disclosure are as follows.

1. According to the portable picnic barbecue grill, the top of the furnace shell is provided with three movable brackets that are rotatably connected by a mounting frame, a furnace end is automatically adaptable to the bottom of the pot through the movable brackets and is suitable for different sizes of woks or grills. The present disclosure has a wide range of applications. At the same time, a blower nozzle connected to an air blower is provided at the bottom of the furnace shell, the top of the hearth is provided with a feeding hopper, and the bottom of the hearth is provided with a combustion chamber. The feeding hopper and the combustion chamber are combined to form an I-shaped structure. Combined with the installation of the air blower, the flame can be concentrated in the middle, which is not dispersive, good in heating effect and fuel-saving.

2. In addition, a feeding port is further provided on the top of the furnace shell. The feeding port is a slope structure with a certain angle. The bottom end of the feeding port is connected with the feeding hopper, so that the grill on the movable bracket does not need to be removed to add fuel to the hearth at any time. It is convenient to use and easy to operate. A detachably connected “concave”-type anti-scalding handle is further provided on the outside of the furnace shell, which is convenient to move the furnace shell and avoids burns when cleaning and moving after barbecuing to enhance the safety of use. A force support point is provided on the inside of the furnace shell, which can bear vertical force and can bear more than 100 kg, and has strong stability without welding.

3. The barbecue grill in the present disclosure can be used not only for barbecuing, but also for cooking. A wok can be placed on the furnace end holder, which can be sold together with a spatula, a barbecue grill, etc. It mainly uses biomass fuel to provide heat. It can be ignited only with toilet paper, which is low in cost and less in ash. It can also burn ordinary wood, branches, etc., with sufficient combustion.

### BRIEF DESCRIPTION OF THE DRAWINGS

The accompanying drawings are used to provide a further understanding of the present disclosure, and constitute a part of the specification. Together with the embodiments of the present disclosure, the accompanying drawings are used to explain the present disclosure and do not constitute a limitation to the present disclosure. In the accompanying drawings:

FIG. 1 is a schematic diagram of the structure according to the present disclosure;

FIG. 2 is a schematic diagram of a front cross-sectional structure according to the present disclosure;

FIG. 3 is a schematic diagram of a top structure according to the present disclosure;

FIG. 4 is a schematic diagram of a bottom structure according to the present disclosure.

In the figures: 1, furnace shell; 101, feeding port; 102, blower nozzle; 103, ventilation hole; 2, hearth; 201, blanking port; 202, air vent; 21, feeding hopper; 22, combustion chamber; 3, supporting tripod; 31, fixing frame; 4, movable bracket; 41, mounting frame; 5, anti-scald handle; 6, air blower; 7, supporting rod.

### DESCRIPTION OF THE EMBODIMENTS

The technical solutions in the embodiments of the present disclosure will be clearly and completely described hereinafter in conjunction with the accompanying drawings in the embodiments of the present disclosure. Obviously, the described embodiments are only a part of the embodiments of the present disclosure, rather than all the embodiments. Based on the embodiments of the present disclosure, all other embodiments obtained by those skilled in the art without creative work shall fall within the protection scope of the present disclosure.

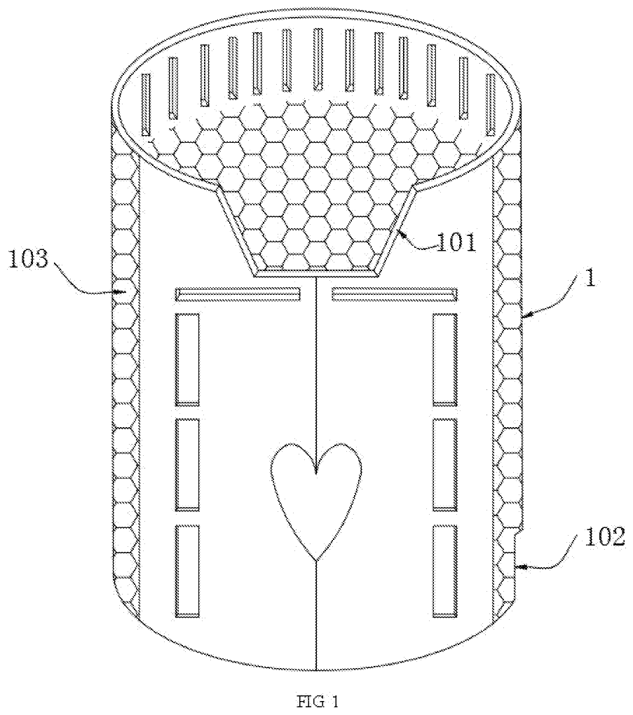

Referring to FIGS. 1-4, the present disclosure provides the following technical solutions: a portable picnic barbecue grill, comprising a furnace shell 1, wherein the top side of the furnace shell 1 is provided with a feeding port 101 with a slope structure, and the bottom side of the furnace shell 101 is provided with a blower nozzle 102. Before use, the output end of the air blower 6 is mounted into the blower nozzle 102 of the furnace shell 1 and communicates with the hearth 2. When in use, the air blower 6 is opened and then the ignited paper is put into the feeding hopper 21. The biomass pellets are put into the feeding hopper immediately. The barbecue frame is placed on the movable bracket 4 for barbecue after being ignited. In the process of barbecue, biomass pellet fuel can be added into the feeding port 101 to increase the flame combustion. The inside of the furnace shell 1 is fixedly provided with a hearth 2, the hearth 2 comprises a feeding hopper 21 at the top and a combustion chamber 22 at the bottom, and the feeding hopper 21 and the combustion chamber 22 are combined to form the hearth 2 with an I-shaped structure. The feeding hopper 21 and the combustion chamber 22 are combined to form an I-shaped structure. Combined with the installation of the air blower 6, the flame can be concentrated in the middle, which is not dispersive, good in heating effect and fuel-saving. The bottom end of the furnace shell 1 is screwed and fixed with a supporting tripod 3 through a fixing frame 31, the top end of the furnace shell 1 is fixedly provided with a movable bracket 4 through a mounting frame 41, and the movable bracket 4 is rotatably connected with the mounting frame 41. A furnace end is automatically adaptable to the bottom of the pot through the, movable brackets 4 and is suitable for different sizes of woks or grills. The present disclosure has a wide range of applications. The outer bottom end of the furnace shell 1 is screwed and fixed with an air blower 6. The air blower 6 can accelerate the burning speed of the flame in the hearth 2, thereby speeding up the ignition speed of the charcoal fire, and saving time. The output end of the air blower 6 passes through the blower nozzle 102 and communicates with the inside of the combustion chamber 22, and the air blower 6 is electrically connected to an external power supply.

In this embodiment: the bottom of the furnace shell 1 is provided with a blower nozzle 102 connected to the air blower 6, the top of the hearth 2 is provided with a feeding hopper 21, and the bottom of the hearth 2 is provided with a combustion chamber 22. The feeding hopper 21 and the combustion chamber 22 are combined to form an I-shaped structure. Combined with the installation of the air blower 6, the flame can be concentrated in the middle, which is not dispersive, good in heating effect and fuel-saving. In addition, a feeding port 101 is further provided on the top of the furnace shell 1. The feeding port 101 is a slope structure with a certain angle. The bottom end of the feeding port 101 is connected with the feeding hopper 21, so that the grill on the movable bracket 4 does not need to be removed to add fuel to the hearth 2 at any time. It is convenient to use and easy to operate. A detachably connected “concave”-type anti-scalding handle 5 is further provided on the outside of the furnace shell 1, which is convenient to move the furnace shell 1 and avoids burns when cleaning and moving after barbecuing to enhance the safety of use. Six force support points are provided on the inside of the furnace shell 1, which can bear vertical force and can bear more than 100 kg, and has strong stability without welding.

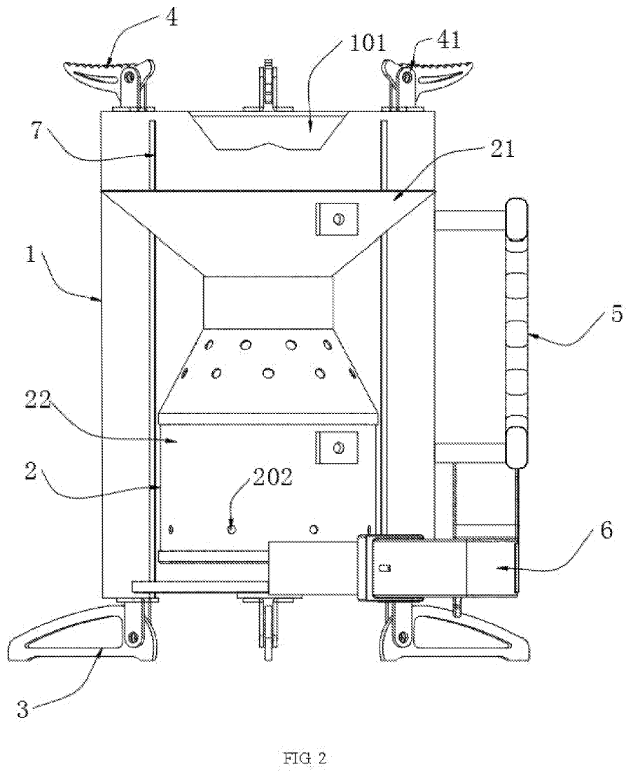

In FIGS. 1-2: the number of the movable brackets 4 and the number of the supporting tripods 3 are both three, and the three supporting tripods 3 and movable brackets 4 are distributed axial-symmetrically on the top and bottom ends of the furnace shell 1. The top contact surface of the mounting frame 41 is provided with a plurality of zigzag protrusions; the supporting tripod 3 is movably connected with the furnace shell 1, the width is small, the occupied area is small, and the stability is strong. The three movable brackets 4 can be used to automatically adjust the support angle during barbecue according to the size of the bottom of the pot, so that the contact area between the bottom of the pot and the movable bracket 4 is always maintained at a stable angle, so as to meet the needs of placing, and supporting woks of different sizes, which has a wide range of use and a good supporting effect. Both the feeding hopper 21 and the combustion chamber 22 are provided with a plurality of air vents 202. A plurality of ventilation holes 103 are provided on the furnace shell 1, so that the flame in the furnace shell 1 is in contact with the outside air to accelerate the burning speed of the flame. The inner wall of the furnace shell 1 is fixedly provided with six supporting rods 7 distributed axial-symmetrically. Six force support points are provided in total, which can bear vertical force and can bear more than 100 kg without welding. It is good in bearing performance, strong in stability, free of welding, low in production cost, and high in use efficiency.

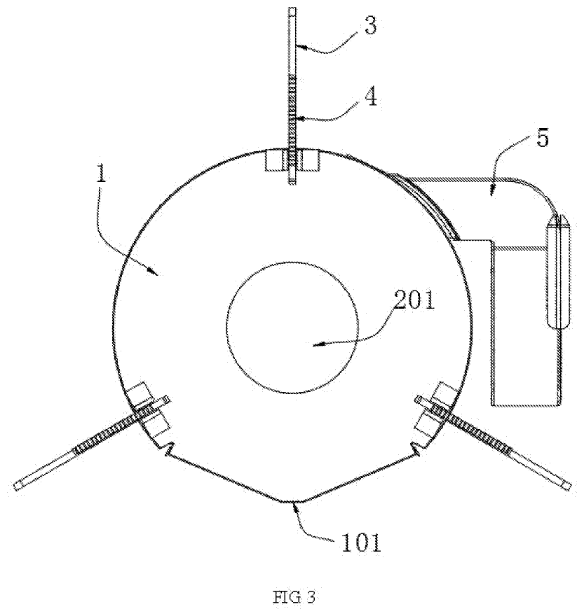

In FIG. 3, a blanking port 201 is provided in the middle of the feeding hopper 21, and the output end of the feeding port 101 is connected with the input end of the blanking port 201; when in use, the air blower 6 is opened and then the ignited paper is put into the feeding hopper 21. The biomass pellets are put into the feeding hopper immediately. The barbecue frame is placed on the movable bracket 4 for barbecue after being ignited. In the process of barbecue, biomass pellet fuel can be added into the feeding port 101 to increase the flame combustion. The feeding port 101 is a slope structure with a certain angle. The bottom end of the feeding port 101 is connected with the feeding hopper 21, so that the grill on the movable bracket 4 does not need to be removed to add fuel to the hearth 2 at any time. It is convenient to use and easy to operate.

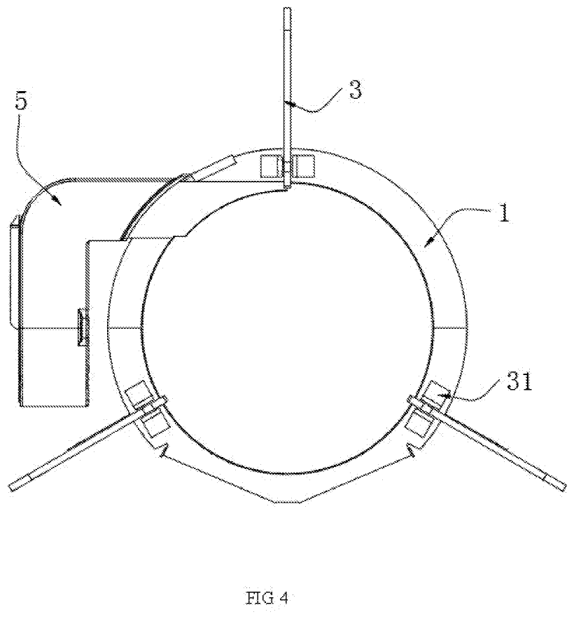

In FIG. 4: the outer wall of the furnace shell 1 is screwed with an anti-scald handle 5, the anti-scalding handle 5 is a “concave”-type structure, and the grip part of the anti-scalding handle 5 is covered with a rubber sleeve; a detachably connected “concave”-type anti-scald handle 5 is provided on the outside of the furnace shell 1, which is convenient to move the furnace shell 1 and avoids burns when cleaning and moving after barbecuing to enhance the safety of use.

The working principle and use process of the present disclosure are as follows: before use, the output end of the air blower 6 is mounted into the blower nozzle 102 of the furnace shell 1 and communicates with the hearth 2. When in use, the air blower 6 is opened and then the ignited paper is put into the feeding hopper 21. The biomass pellets are put into the feeding hopper immediately The barbecue frame is placed on the movable bracket 4 for barbecue after being ignited. In the process of barbecue, biomass pellet fuel can be added into the feeding port 101 to increase the flame combustion. According to the present disclosure, the top of the furnace shell 1 is provided with three movable brackets 4 that are rotatably connected by a mounting frame 41, and a furnace end is automatically adaptable to the bottom of the pot through the movable brackets 4 and is suitable for different sizes of woks or grills. The present disclosure has a wide range of applications. At the same time, a blower nozzle 102 connected to an air blower 6 is provided at the bottom of the furnace shell 1, the top of the hearth 2 is provided with a feeding hopper 21, and the bottom of the hearth 2 is provided with a combustion chamber 22. The feeding hopper 21 and the combustion chamber 22 are combined to form an I-shaped structure. Combined with the installation of the air blower 6, the flame can be concentrated in the middle, which is not dispersive, good in heating effect and fuel-saving. In addition, a feeding port 101 is further provided on the top of the furnace shell 1. The feeding port 101 is a slope structure with a certain angle. The bottom end of the feeding port 101 is connected with the feeding hopper 21, so that the grill on the movable bracket 4 does not need to be removed to add fuel to the hearth 2 at anytime. It is convenient to use and easy to operate. A detachably connected “concave”-type anti-scalding handle 5 is further provided on the outside of the furnace shell 1, which is convenient to move the furnace shell 1 and avoids burns when cleaning and moving after barbecuing to enhance the safety of use. Six force support points are provided on the inside of the furnace shell 1, which can bear vertical force and can bear more than 100 kg, and has strong stability without welding.

It should be noted that in the present disclosure, relational terms such as first and second are only used to distinguish one entity or operation from another entity or operation, and do not necessarily require or imply that there is any such actual relationship or order between these entities or operations. Moreover, the terms “comprise”, “include” or any other variants thereof are intended to cover non-exclusive inclusion, so that a process, method, article, or device that comprises a series of elements comprises not only those elements, but also comprises other elements not explicitly listed, or further comprises elements inherent to this process, method, article or device. Without more restrictions, there is the phrase “comprising a limited element without excluding the existence of other identical elements in the process, method, article, or device comprising the element.”

Although the embodiments of the present disclosure have been shown and described, those skilled in the art can understand that various changes, modifications, substitutions, and variations can be made to these embodiments without departing from the principle and spirit of the present disclosure. The scope of the present disclosure is defined by the appended claims and their equivalents.

What is claimed is:

1. A portable picnic barbecue grill, comprising a furnace shell (1), wherein the top side of the furnace shell (1) is provided with a feeding port (101) with a slope structure, the bottom side of the furnace shell (1) is provided with a blower nozzle (102), the inside of the furnace shell (1) is fixedly provided with a hearth (2), the hearth (2) comprises a feeding hopper (21) at the top and a combustion chamber (22) at the bottom, the feeding hopper (21) and the combustion chamber (22) are combined to form the hearth (2) with an I-shaped structure, the bottom end of the furnace shell (1) is screwed and fixed with a supporting tripod (3) through a fixing frame (31), the top end of the furnace shell (1) is fixedly provided with a movable bracket (4) through a mounting frame (41), the movable bracket (4) is rotatably connected with the mounting frame (41), the outer bottom end of the furnace shell (1) is screwed and fixed with an air blower (6), the output end of the air blower (6) passes through the blower nozzle (102) and communicates with the inside of the combustion chamber (22), and the air blower (6) is electrically connected to an external power supply.

2. The portable picnic barbecue grill according to claim 1, wherein the number of the movable brackets (4) and the number of the supporting tripods (3) are both three, and the three supporting tripods (3) and movable brackets (4) are distributed axial-symmetrically on the top and bottom ends of the furnace shell (1).

3. The portable picnic barbecue grill according to claim 1, wherein the top contact surface of the mounting frame (41) is provided with a plurality of zigzag protrusions.

4. The portable picnic barbecue grill according to claim 1, wherein a blanking port (201) is provided in the middle of the feeding hopper (21), and the output end of the feeding port (101) is connected with the input end of the blanking port (201).

5. The portable picnic barbecue grill according to claim 1, wherein both the feeding hopper (21) and the combustion chamber (22) are provided with a plurality of air vents (202).

6. The portable picnic barbecue grill according to claim 1, wherein the inner wall of the furnace shell (1) is fixedly provided with six supporting rods (7) distributed axial-symmetrically.

7. The portable picnic barbecue grill according to claim 1, wherein a plurality of ventilation holes (103) are provided on the furnace shell (1).

8. The portable picnic barbecue grill according to claim 1, wherein the outer wall of the furnace shell (1) is screwed with an anti-scalding handle (5), the anti-scalding handle (5) is a “concave”-type structure, and the grip part of the anti-scalding handle (5) is covered with a rubber sleeve.

9. The portable picnic barbecue grill according to claim 1, wherein the supporting tripod (3) is movably connected with the fixing frame (31).
